(19) United States
(12) Patent Application Publication
(10) Pub. No.: US 2016/0225153 A1
(43) Pub. Date: Aug. 4, 2016

(54) APPARATUS AND METHOD FOR TRACKING EYE-GAZE

(71) Applicant: Electronics and Telecommunications Research Institute, Daejeon (KR)

(72) Inventor: Jae Han KIM, Gwacheon-si Gyeonggi-do (KR)

(21) Appl. No.: 15/009,419

(22) Filed: Jan. 28, 2016

(30) Foreign Application Priority Data
Jan. 30, 2015 (KR) 10-2015-0015490

(51) Int. Cl. G06T 7/00; G06K 9/00

(52) U.S. Cl. CPC G06T 7/0044; G06T 7/0065; G06K 9/00604; G06T 2207/10028; G06T 2207/30201

(57) ABSTRACT

Provided herein are a processing apparatus and a control method thereof capable of determining a position or a direction at which a user looks by using an image of both eyes, and more particularly, to an apparatus for determining a position of a point or a direction in space at which the user looks by obtaining a two-dimensional image together with a distance image using a stereo camera or a multi-view camera, or by using a two-dimensional image together with a distance image obtained using information on a general camera and a depth camera.

### CROSS-REFERENCE TO RELATED APPLICATION

The present application claims priority to Korean patent application number 10-2015-0015490 filed on Jan. 30, 2015, the entire disclosure of which is incorporated herein in its entirety by reference.

### BACKGROUND

1. Field of Invention

Various embodiments of the present disclosure relate to an apparatus and a method for tracking eye-gaze, and more particularly, to an apparatus and a method for tracking eye-gaze of a user using an image of both eyes.

2. Description of Related Art

In recent years, research and development for an apparatus and a method for improving user convenience by controlling a digital apparatus based on results obtained by tracking user's pupils or eye-gaze or using the tracking information have been actively conducted. In detail, a device is controlled to be suitable for a user's behavior pattern by extracting features of the pupils of both eyes from an image obtained from a single camera or a stereoscopic camera and then calculating the positions of pupils, an eye-gaze direction, or the like using the extracted features. As a use example of eye-gaze tracking technology, there are functions of temporarily stopping video playback when an eye-gaze looks at places other than a screen when using a cellular phone, turning on and off a display, or the like. To normally operate the functions using the eye-gaze tracking technology, accurate control of the functions cannot be achieved by a scheme that simply uses only the positions of the pupils, but may be achieved only when the user knows information on places at which the eye-gaze looks or the eye-gaze direction. Therefore, various technologies for determining a gazing point in a three-dimensional space in real time have been proposed.

Meanwhile, existing technologies do not determine places or directions at which a user' eye-gaze looks but mostly determine only the positions of pupils independent of places at which the user's eye-gaze looks. That is, the existing technologies consider that the user gazes forward when a camera cannot recognize the user's pupils, even though a user gazes at other places. Further, even in the case of tracking the user's eye-gaze, the existing technologies may perform eye-gaze tracking only at a specific position, or need to be provided with a user's position, characteristic information, or the like, and as a result the user's freedom is limited. That is, the existing technologies may be operated only in limited environments and may have a large error when used outside of such limited environments.

As a technology used for the eye-gaze tracking, there is a pupil-corneal reflection scheme. The pupil-corneal reflection scheme is a scheme of determining directions at which eyes look by analyzing a pupil's pattern and a glint pattern, which is light reflected from the cornea. In this case, when the position of a light source generating the glint with respect to an image acquisition camera is changed or the user's position with respect to the image acquisition camera is changed, accurate eye-gaze tracking may not be achieved.

As another technology for the eye-gaze tracking, there is a scheme of tracking eye-gaze based on an image analysis of patterns of boundary lines of pupils or irises of both eyes. However, a scheme of determining the direction of gazing in a three-dimensional space by analyzing a two-dimensional image is mainly used, and therefore even in this case, when a user's distance or a face angle with respect to the camera is changed, an error may frequently occur.

### SUMMARY

Various embodiments of the present disclosure are directed to an apparatus and a method for tracking eye-gaze.

Furthermore, various embodiments of the present disclosure are directed to an apparatus and a method for determining one point in a three-dimensional space at which a user gazes or a direction in the three-dimensional space at which the user gazes by determining user's directions of gazing from an image of both eyes of a user or determining a gazing direction vector in a three-dimensional space using a three-dimensional position of a pupil.

One embodiment of the present disclosure provides a method for tracking a user's eye-gaze including: acquiring an image of both eyes of a user; acquiring information on distances up to pupils or irises of the both eyes; and determining a user's gazing point based the image of both eyes of the user and the distance information.

Another embodiment of the present disclosure provides an apparatus for tracking a user's eye-gaze including: a first camera acquiring an image of both eyes of a user; a second camera acquiring information on distances up to pupils or irises of both eyes of the user, and determining a user's gazing point based on the image of both eyes of the user and the distance information.

The present disclosure acquires coordinates in the three-dimensional space at which both eyes gaze from both eyes of the user and the distance information after the image and distances of both eyes are acquired from the two-dimensional camera and the three-dimensional coordinate acquisition apparatus (or camera).

Further, the present disclosure secures the user's freedom by preventing the tracking accuracy from being reduced even when the user changes posture or moves.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a conceptual diagram for describing a concept of eye-gaze tracking in a three-dimensional coordinate system, according to an embodiment of the present disclosure;

FIGS. 2A to 2D are diagrams illustrating various examples of a circle configured of a boundary line;

FIG. 3 is a flow chart illustrating a method for tracking eye-gaze according to an embodiment of the present disclosure;

FIG. 4 is a flow chart illustrating a method for determining a gazing point based on an image of both eye and the distance information; and

FIG. 5 is a block diagram illustrating a configuration of an apparatus for tracking eye-gaze according to the embodiment of the present disclosure.

### DETAILED DESCRIPTION

Hereinafter, embodiments of the present disclosure will be described in detail with reference to the accompanying drawings.

In describing the embodiments of the present disclosure, a description of technical contents which are well known to the art to which the present disclosure belongs and are not directly connected with the present disclosure will be described. The reason is that an unnecessary description is omitted to make the gist of the present disclosure clear.

Various advantages and features of the present disclosure and methods accomplishing the same will become apparent from the following detailed description of embodiments with reference to the accompanying drawings. However, the present disclosure is limited to embodiments disclosed below, but may be implemented in various different forms. These embodiments will be provided only in order to make the disclosure of the present disclosure complete and allow those skilled in the art to which the present disclosure pertains to completely recognize the scope of the present disclosure.

Terms used in the present disclosure will be defined.

In the present specification, the term “both eyes” means both of the user's eyes, and may be used as having the same meaning as “pupil” or “iris”.

In the present specification, the term eye-gaze or gazing may be a point or a position at which both the user's eyes gaze. An eye-gaze direction or a gazing direction may be a point at which a user's eye-gaze looks or a direction at which a user gazes that is a direction determined based on a user.

In the present specification, the term “boundary circle” may be used to represent a circle recognized by a boundary line when a figure formed by the boundary line has a circular shape.

The present specification describes, for example, performing eye-gaze tracking by determining a gazing point based on a camera acquiring a two-dimensional image, a distance measuring camera, or a distance acquisition apparatus, but the present disclosure is not limited thereto. Therefore, it is to be noted that the present disclosure may be applied to various apparatuses or methods for tracking an eye-gaze direction or a gazing point such as tracking the pupils of a human or an animal, an eye-gaze direction of a human or an animal, tracking moving objects, or the like using the method and/or apparatus for tracking eye-gaze according to the embodiment of the present disclosure.

The gist of the present disclosure may be achieved by a first camera for acquiring an image of both eyes, a second camera or a distance acquisition apparatus for measuring distances to boundaries of pupils or irises of both eyes, an apparatus or a module for extracting the boundary line of the pupils or the irises from the image of both eyes, an apparatus or a module for calculating a rotation angle of a circle from the boundary line under the assumption that the extracted boundary line is an ellipse and the ellipse is projected from the circle, and an apparatus or a module for calculating a gazing angle or a gazing point from the rotation angle and the information on the distance up to the boundary line.

When observing the iris in the image of both eyes, the iris has a boundary line that distinguishes it from a sclera, which is the white of the eye. When an eye looks into the lens of a camera, the boundary line is a circle, and when an eye doesn't look into a camera, the boundary line is an ellipse.

Even in the case of a boundary line formed by the pupil and the iris, similarly, when the eye looks directly into a camera, the boundary line is a circle and when the eye doesn't look directly into the camera, the boundary line is an ellipse. When the ellipse is acquired by the camera, the rotated angle may be calculated from the ellipse based on the degree to which an original circle rotates with respect to an x axis and a y axis before being projected on the camera. When the angle is calculated, a normal vector of a plane formed by the ellipse, that is, the boundary line, may be calculated. Further, coordinates in a three-dimensional space coordinate system for the boundary line may be known by the camera or the distance acquisition apparatus for measuring the distances to the boundaries of the pupils or irises of the both eyes, and as a result three-dimensional coordinate points of the center of the circle derived from the ellipse may be obtained. Therefore, if the coordinates of the center of the circle in the three-dimensional space coordinate system are known and the normal vector is calculated, the direction in which each eye gazes is known. Next, the place where the directions of gazing of both eyes coincide with each other becomes the gazing point. When the gazing point is continuously found, eye-gaze tracking may be performed.

Hereinafter, embodiments of the present disclosure will be described with reference to the accompanying drawings.

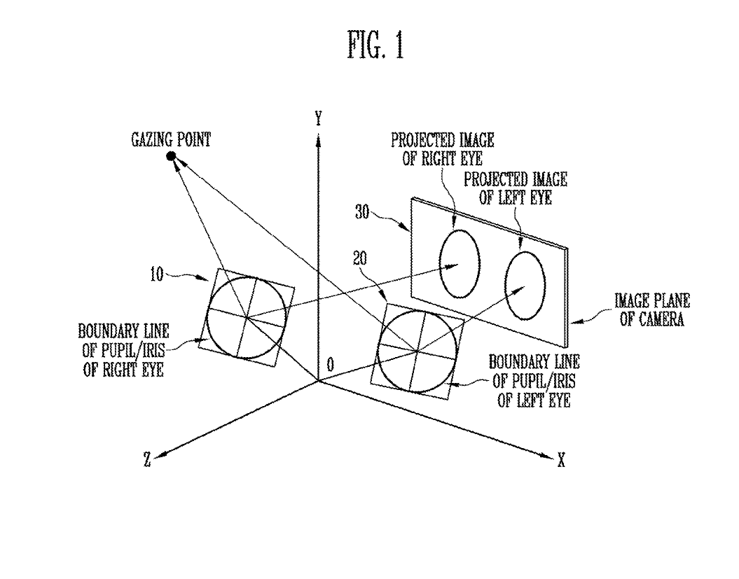

FIG. 1 is a conceptual diagram for describing a concept of eye-gaze tracking in a three-dimensional coordinate system, according to an embodiment of the present disclosure.

Referring to FIG. 1, it may be considered that both the user's eyes are positioned in a space described by a three-dimensional coordinate system (x, y, and z axes). In this case, the boundary lines of the pupils or the irises of each eye are each positioned in their unique planes, in which it may be considered that the planes are positioned in respective independent spaces, but not on a co-plane. The boundary lines of the pupils or irises of both the user's eyes may be recognized by the camera and a boundary line 10 of a pupil or an iris of a right eye and a boundary line 20 of a pupil or an iris of a left eye basically have a circular shape having the same diameter. When the user looks directly into the camera, that is, an image plane of the camera, in other words, when the central axis of a boundary circle and a camera axis coincide with each other on a plane where a boundary circle of the pupil or the iris is present, if the boundary lines of the pupils or irises of both eyes are projected on an image plane 30 of the camera, the projected images may be circles, but not ellipses.

However, in most situations, the pupil or the iris moves vertically and horizontally according to the user's gaze, and therefore when this is projected on the image plane of the camera, the projected images of the right eye and the left eye having the elliptical shape are acquired as illustrated in FIG. 1.

Therefore, in the projected image of the right eye, the elliptical shape may change depending on the angle formed by the plane containing the boundary of the right eye and the image plane of the camera. Therefore, reversely, the angle formed by the boundary circle, that is, the boundary line of the pupil or the iris of the right eye and the camera axis may be calculated by the elliptical shape projected on the image plane of the camera. Like the case of the left eye, the angle formed by the boundary circle of the left eye and the camera axis may be calculated from the elliptical shape.

If the directions of each boundary circle and the centers of each circle are known, the normal vector at the centers of each boundary circle in the plane in the three-dimensional coordinate system may be calculated. If the central coordinates of the circle and the normal vector at the central coordinates of the circle are obtained, the direction in which the user is gazing may be determined. In detail, if the vectors for the directions of gazing of each eye are obtained on the space, the gazing point may be the intersection point of the two gazing vectors.

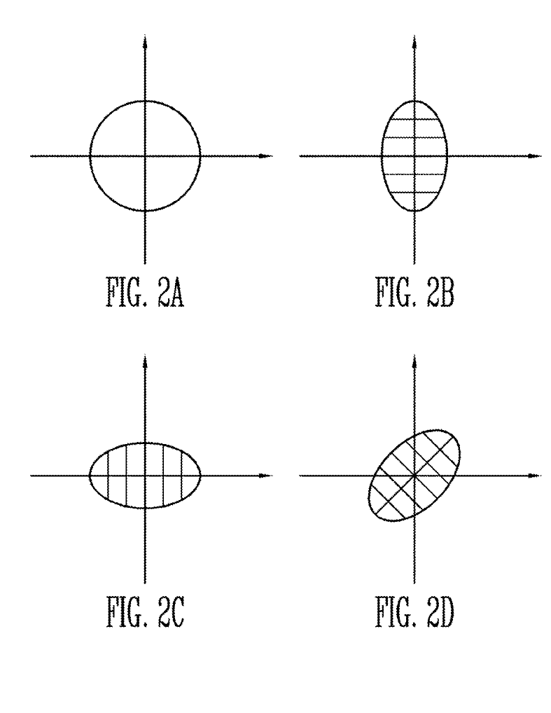

FIGS. 2A to 2D are diagrams illustrating various examples of the circle configured of the boundary line.

As described above, the boundary lines of the pupils or irises of both the user's eyes may be recognized by the camera and the boundary line of the pupil or the iris of the right eye and the boundary line of the pupil or the iris of the left eye basically have the shapes of circles.

As illustrated in FIG. 2A, when the user looks directly into the camera, that is, the image plane of the camera, in other words, when the central axis of the boundary circle and the camera axis coincide with each other in the plane containing the boundary circle of the pupil or the iris, if the boundary lines of the pupils or irises of both eyes are projected in the image plane of the camera, the projected image may be circles, but not ellipses. This is illustrated in FIG. 2A.

If the user's eye-gaze or direction of gazing is changed, the boundary circle projected on the image plane of the camera may be an elliptical shape according to the rotation direction. If it is assumed that the boundary circle rotates in a horizontal direction, that is, with respect to a vertical axis, it may be appreciated that the boundary circle is projected as an ellipse having the shape illustrated in FIG. 2B.

FIG. 2C illustrates the case in which the circle in the plane rotates in the horizontal direction with respect to the image plane of the camera, that is, with respect to the horizontal axis, by the same scheme. Consequently, in the general case, in which the circle rotates with respect to both of the vertical axis and the horizontal axis, it may be appreciated that the circle is projected in the shape of FIG. 2D, which may correspond to the case in which the user looks the camera from an arbitrary position.

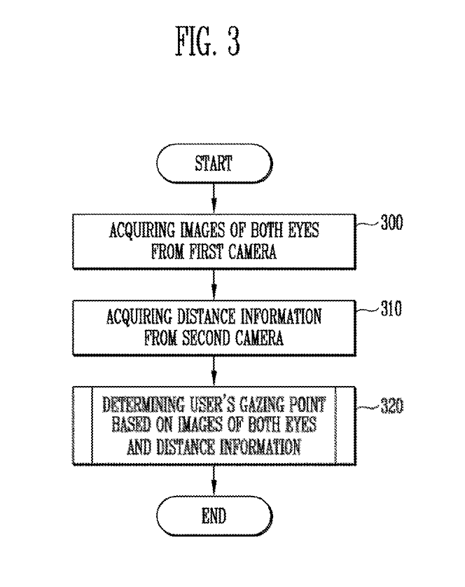

FIG. 3 is a flow chart illustrating a method for tracking eye-gaze according to an embodiment of the present disclosure.

Referring to FIG. 3, first, the method for tracking eye-gaze may acquire the image of both eyes of the user from a first camera (at 300). Here, the kind of the first camera is not limited as long as the first camera may capture the image of both eyes of the user.

At step 310, a second camera may acquire the information on the distances to both the user's eyes. In detail, the distance information may have a form of a three-dimensional coordinate value. Further, as the second camera, various cameras capable of measuring the distances to the boundaries of the pupils or the irises of both the user's eyes or acquiring the corresponding distance information may be used.

Meanwhile, the steps 300 and 310 are not necessarily performed sequentially but may be performed in reverse. That is, any one of the step of acquiring the image of both eyes of the user and the step of acquiring the distance information is not necessarily performed ahead of the other thereof. Further, the step of acquiring the image of both eyes of the user and the step of acquiring the distance information may also be performed by the same camera, or may be performed simultaneously by different cameras.

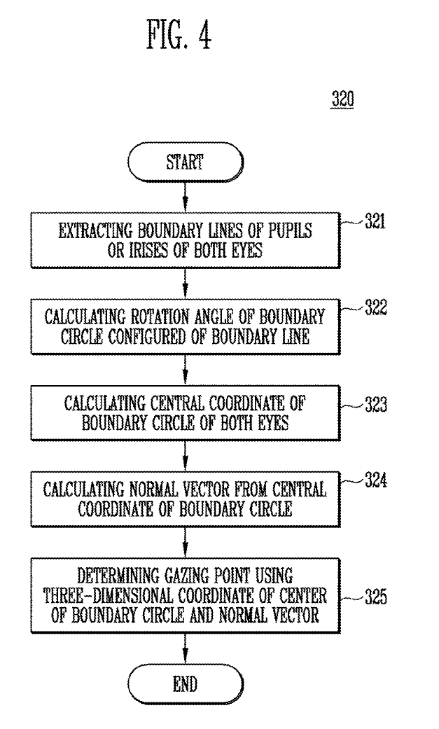

The apparatus for tracking eye-gaze may determine the user's gazing point based on the image of both eyes of the user and the distance information acquired using the first camera and the second camera (at 320). Here, a detailed method for determining a user's gazing point by the apparatus for tracking eye-gaze will be described in more detail with reference to FIG. 4.

FIG. 4 is a flow chart illustrating a method for determining a gazing point based on the image of both eyes of the user and distance information.

Referring to FIG. 4, the apparatus for tracking eye-gaze may extract the boundary lines of the pupils or the irises of both eyes from the first acquired image of both eyes (at 321). The extracted boundary line may form a circle or an ellipse. In this case, the shape of the ellipse or lengths of major and minor axes may be different depending on the user's directions of gazing of both eyes. As described in detail with reference with FIG. 2, the boundary line may be extracted as a circle or an ellipse depending on the rotation amount in the horizontal or vertical direction with respect to the central axis of the boundary circle of the pupil or the iris and the camera axis.

Next, the apparatus for tracking eye-gaze may calculate the rotation angle of the boundary circle configured of the boundary line (at 322). The method for calculating a rotation angle of a boundary circle configured of the boundary line by the apparatus for tracking eye-gaze will be described below in more detail.

First, assuming a simple circle present at an original point, the Equation of a circle is as the following Equation 1.

$$\frac{{x}^{2}}{{r}^{2}} + \frac{{y}^{2}}{{r}^{2}} = 1 \qquad [ Equation 1 ]$$

Meanwhile, when a circle generated by rotating the circle of the above Equation 1 by an angle θ with respect to a vertical axis is projected, the Equation of an ellipse is as the following Equation 2.

$$\frac{{x}^{2}}{{[ r \cdot cos θ ]}^{2}} + \frac{{y}^{2}}{{r}^{2}} = 1 \qquad [ Equation 2 ]$$

Further, when a circle generated by rotating the circle of the above Equation 1 by an angle φ with respect to a horizontal axis is projected, the Equation of an ellipse is as the following Equation 3.

$$\frac{{x}^{2}}{{r}^{2}} + \frac{{y}^{2}}{{[ r \cdot cos φ ]}^{2}} = 1 \qquad [ Equation 3 ]$$

Consequently, when the circle rotated by the angle θ with respect to the vertical axis and the circle rotated by the angle φ with respect to the horizontal axis are projected, the Equation of an ellipse is as the following Equation 4.

$$\frac{{x}^{2}}{{[ r \cdot cos θ ]}^{2}} + \frac{{y}^{2}}{{[ r \cdot cos φ ]}^{2}} = 1 \qquad [ Equation 4 ]$$

Therefore, if the Equation of an ellipse is given as the above Equation 4, the three-dimensional space is assumed based on the above Equation, and if the ellipse is rotated by an angle −θ with respect to the vertical axis and an angle −φ with respect to the horizontal axis, the original circle may be obtained on the plane.

Rotating the above Equation 4 by an angle w with respect to a camera coordinate system is represented by the following Equation 5.

$$\frac{{( x cos ω + y sin ω )}^{2}}{{[ r \cdot cos θ ]}^{2}} + \frac{{( y cos ω - x sin ω )}^{2}}{{[ r \cdot cos φ ]}^{2}} = 1 \qquad [ Equation 5 ]$$

Therefore, it may be appreciated from the above-mentioned principle that the boundary circle of the pupil or the iris extracted at step 321 is rotated by the angle −θ with respect to the vertical axis, the angle −φ with respect to the horizontal axis, and the angle w with respect to the camera coordinate system. Based on this, the rotation angle of the boundary circle may be obtained at step 322.

At step 323, the apparatus for tracking eye-gaze may obtain central coordinates of the boundary circle of both eyes. That is, in the case of the ellipse, when a major axis and a minor axis are obtained, the central point of the ellipse, which is the intersecting point of the major axis and the minor axis, becomes the same point as the center of the circle in the plane containing the boundary of the circle in the three-dimensional space, that is, the boundary circle of the pupil or the iris.

In detail, the major axis and the minor axis of the ellipse may be obtained by substituting the coordinate values of the ellipse into a general formula. Further, in various examples, only a portion of the ellipse may be used. That is, only a portion of the ellipse may be acquired from the actually acquired two-dimensional image. In this case, n coordinate values (n>1) among some coordinate values of the ellipse are substituted into a general formula of the ellipse to obtain the major axis and the minor axis.

In the case of using a portion of the ellipse, when the ellipse is the boundary of the pupil, only the boundary generated by the iris and the pupil is valid as the boundary line, and in the case of using the boundary of the iris, only the boundary of the iris and the sclera is valid as the boundary line.

A method for calculating three-dimensional coordinates of a center of a circle by obtaining a center of an ellipse may also obtain a distance value using a stereo camera based on a disparity and may obtain a distance value using a multi-view camera based on the disparity, like the stereo camera type. That is, the three-dimensional coordinates of the center of the circle may be calculated using the distance information acquired at step 310 of FIG. 3.

Alternatively, if some values of the boundary of the ellipse are directly obtained from the three-dimensional camera, the Equation of the circle in the three-dimensional space may be obtained from the value and the three-dimensional coordinates of the center of the circle may also be obtained from the Formula of the circle. That is, if the three-dimensional coordinates of more than n points (n>2) among some values of the circle are known, that is, assuming values of (x1, y1, z1), (x2, y2, z2), and (x3, y3, z3), the three-dimensional coordinate values of the center of the circle may be calculated by substituting the values into the following Equation 6.

$$\frac{{x}^{2}}{{r}^{2}} + \frac{{y}^{2}}{{r}^{2}} + \frac{{z}^{2}}{{r}^{2}} = 1 \qquad [ Equation 6 ]$$

At step 324, the apparatus for tracking eye-gaze may use the calculated rotation angle to calculate the normal vector of the plane formed by the boundary circle. It is to be noted that the normal vector may be obtained by calculating the central coordinates of the boundary circle of both eyes, or an order of the calculation of the normal vector may be changed.

At steps 323 and 324, if the coordinates of the central point of the circle in the three-dimensional spatial coordinate system are known and the normal vector is calculated, the directions of gazing of each eye may be known (at 325). Further, the user's eye-gaze may be tracked by continuously tracking the gazing point.

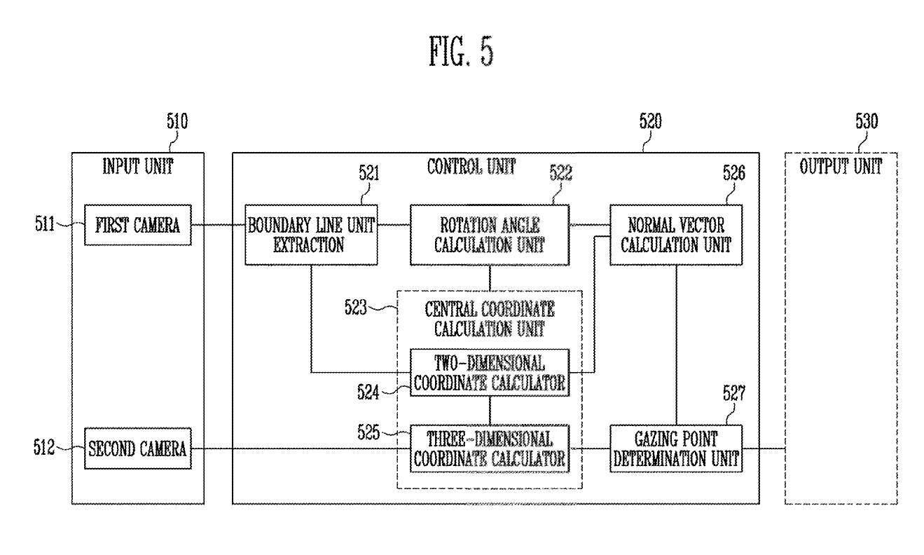

FIG. 5 is a block diagram illustrating the configuration of the apparatus for tracking eye-gaze according to the embodiment of the present disclosure.

Referring to FIG. 5, the apparatus for tracking eye-gaze according to the embodiment of the present disclosure may include an input unit 510, a control unit 520, and an output unit 530. The input unit 510 may receive the image of both eyes of the user or information on distances to the pupils or the irises of the both eyes. In more detail, the input unit may include a first camera 511 and a second camera 512.

The first camera 511 may acquire the image of both eyes of the user. That is, the first camera 511 acquires the image of both eyes, respectively, from the front of the face. The image of both eyes is not necessarily the front, and therefore it is sufficient to acquire the boundary of the pupil or the iris as a two-dimensional image. The kind of the first camera is not limited and therefore various two-dimensional cameras may be used.

The second camera 512 may acquire the information on the distances up to the pupils or the irises of both the user's eyes. The second camera may be a three-dimensional camera in various examples.

For convenience of description, in the present specification, the first camera 511 and the second camera 512 are separately described, but in various examples, it is to be noted that the first camera 511 and the second camera 512 may be implemented as one camera. Alternatively, the same camera may also receive the image of both eyes and the distance information, sequentially or simultaneously.

The control unit 520 controls the overall operation of the apparatus for tracking eye-gaze. The input unit 510, the control unit 520, and the output unit 530 may each be separate electronic devices and modules provided in the electronic devices. However, for convenience of explanation, in the present specification, the form in which the input unit 510 and the control unit 520 are coupled to each other will be described. Further, the control unit 520 may include a boundary line extraction unit 521, a rotation angle calculation unit 522, a central coordinate calculation unit 523, a normal vector calculation unit 526, and a gazing point determination unit 527. Further, the central coordinate calculation unit 523 may further include a two-dimensional coordinate calculator 524 and a three-dimensional coordinate calculator 525. However, the control unit 520 receives a signal of the input unit 510 and controls all signal processing for tracking eye-gaze based on the received signal, and therefore it is to be noted that the control unit 520 may be designed to be integrated as one module. Further, each module may be implemented as a separate device, or may be configured to be integrated as a single piece of hardware.

For convenience of explanation, in the present specification, each module is not operated individually, but the control unit 520 controls the overall operation, but in the following description each module individually performs the operation of the control unit 520.

The control unit 520 may acquire the boundary lines of the pupils or the irises from the image of both eyes, calculate the rotation angle of the ellipse formed by each of the acquired boundary lines, calculate the normal vector based on the calculated rotation angle, calculate the central coordinates of the pupils or the irises of both the user's eyes, and determine the user's gazing point based on the normal vector and the central coordinates.

Further, the control unit 52 may calculate the normal vector at the central coordinates of the pupils or the irises of both the user's eyes and determine the gazing point based on the central coordinates of the pupils or the irises of both the user's eyes and the normal vector.

Further, the control unit 520 may use only a portion of the ellipse formed by the boundary line.

Hereinafter, when each module within the controller 520 is implemented as a separate module, the operation of main modules will be described. The fact that the operations of each module to be described below are integrally performed by the control unit 520 is as described above.

The boundary line extraction unit 521 may extract the boundary lines of the pupils or the irises from the two images acquired from the first camera 511.

The rotation angle calculation unit 522 may calculate the rotation angle of the circle from the boundary line of the ellipse, which is a result obtained by passing the image acquired from the first camera 511 through the boundary line extraction unit 521.

The two-dimensional coordinate calculator 524 may calculate the two-dimensional coordinate value of the center of the boundary circle in the two-dimensional image and transfer the coordinate value to the three-dimensional coordinate calculator 525.

The three-dimensional coordinate calculator 525 measures the distance to the boundary of the user's pupil or iris, or acquires the distance information. Further, the three-dimensional coordinate calculator 525 may calculate the three-dimensional coordinate value at the corresponding coordinates using the two-dimensional coordinate value of the center of the boundary circle transferred from the two-dimensional coordinate calculator 524. In this case, the information on the distance to the entire pupils or irises is not acquired, but the information on the distance to a portion of the boundary circle may also be acquired.

The normal vector calculation unit 526 may calculate the normal vector at the central coordinates of the pupils or the irises of both the user's eyes.

The gazing point determination unit 527 calculates the gazing angle or the gazing point from the rotation angle and the three-dimensional coordinate value of the center of the boundary line.

The output unit 530 may be an external apparatus separately configured from the input unit 510 and the control unit 520 and may be an output unit of upper-level hardware including the apparatus for tracking eye-gaze. The output 530 is not a component essential to implement the method and apparatus for tracking eye-gaze, and therefore is represented by a dotted line in FIG. 5.

The output unit 530 may output the user's gazing point determined by the control unit 520 or the eye-gaze tracking result, which is a result obtained by tracking the gazing point. The output may be output in various forms according to the output unit 530, and the output form is not limited to a specific output method.

Although the embodiments of the present disclosure have been disclosed for illustrative purposes, those skilled in the art will appreciate that various modifications, additions and substitutions are possible, without departing from the scope and spirit of the disclosure as disclosed in the accompanying claims.

Accordingly, the scope of the present disclosure is not construed as being limited to the described embodiments but is defined by the appended claims as well as equivalents thereto.

In the foregoing embodiments of the present disclosure, all the steps may be selectively performed or omitted. Further, steps in each embodiment are not necessarily performed in order and may be performed in reverse. Meanwhile, the embodiments of the present disclosure described in the present specification and shown in the accompanying drawings are only specific examples provided in order to easily describe technical contents of the present disclosure and assist in the understanding of the present disclosure, and are not to limit the scope of the present disclosure. That is, it is obvious to those skilled in the art to which the present disclosure pertains that various modifications may be made without departing from the scope of the present disclosure, in addition to the embodiments disclosed herein.

Although the embodiments of the present disclosure have been illustrated in the present specification and the accompanying drawings and specific terms have been used, they are used in a general meaning in order to assist in understanding the present disclosure and do not limit the scope of the present disclosure. It is obvious to those skilled in the art to which the present disclosure pertains that various modifications may be made without departing from the scope of the present disclosure, in addition to the embodiments disclosed herein.

What is claimed is:

1. A method for tracking an eye-gaze of a user, comprising:
acquiring an image of both eyes of the user;
acquiring information on distances to pupils or irises of the both eyes; and
determining a user's gazing point based on the image of the both eyes and the information on the distances.

2. The method according to claim 1, wherein the determining of the user's gazing point includes;
acquiring boundary lines of the pupils or the irises from the image of the both eyes of the user;
calculating a rotation angle of an ellipse formed by each of the acquired boundary lines;
calculating a normal vector based on the calculated rotation angle;
calculating three-dimensional coordinates of centers of the pupils or the irises of the both eyes of the user; and
determining the user's gazing point based on the normal vector and the three-dimensional coordinates.

3. The method according to claim 1, wherein the image of the both eyes is acquired using a first camera that is a two-dimensional camera.

4. The method according to claim 1, wherein the distance information is acquired using a second camera that is any one of a three-dimensional camera and a distance measuring apparatus.

5. The method according to claim 2, wherein the determining of the user's gazing point based on the normal vector and the three-dimensional coordinates includes:
calculating a normal vector at the three-dimensional coordinates of the centers of the pupils or the irises of the both eyes of the user; and
determining the gazing point based on the three-dimensional coordinates of the pupils or the irises of the both eyes of the user and the normal vector.

6. The method according to claim 2, wherein in the calculating of the central coordinates of the pupils or the irises of the both eyes of the user, only a portion of the ellipse formed by the boundary line is used.

7. An apparatus for tracking an eye-gaze of a user, comprising:
a first camera configured to acquire an image of both eyes of the user;
a second camera configured to acquire information on distances up to the pupils or the irises of the both eyes; and
a control unit configured to determine a user's gazing point based on the image of the both eyes and the distance information.

8. The apparatus according to claim 7, wherein the control unit acquires the boundary lines of the pupils or the irises from the image of the both eyes, calculates a rotation angle of an ellipse formed by each of the acquired boundary lines, calculates a normal vector based on the calculated rotation angle, calculates three-dimensional coordinates of centers of the pupils or the irises of the both eyes of the user, and determines the user's gazing point using the normal vector and the three-dimensional coordinates.

9. The apparatus according to claim 7, wherein the control unit calculates the normal vector at the three-dimensional coordinates of the centers of the pupils or the irises of the both eyes of the user and determines the gazing point using the three-dimensional coordinates of the centers of the pupils or the irises of the both eyes of the user and the normal vector.

10. The apparatus according to claim 8, wherein the control unit uses only a portion of the ellipse formed by the boundary line.
